(19) United States
(12) Patent Application Publication
(10) Pub. No.: US 2024/0308925 A1
(43) Pub. Date: Sep. 19, 2024

(54) VISCOSITY REDUCTION IN ALUMINUM SULFATE SUSPENSIONS USING ALKALI METAL COMPOUNDS

(71) Applicant: SIKA TECHNOLOGY AG, Baar (CH)

(72) Inventors: Martin WEIBEL, Zürich (CH); Christian STENGER, Küttigen (CH)

(73) Assignee: SIKA TECHNOLOGY AG, Baar (CH)

(21) Appl. No.: 18/279,736

(22) PCT Filed: Apr. 27, 2022
(86) PCT No.: PCT/EP2022/061155

§ 371 Date: Aug. 31, 2023

(30) Foreign Application Priority Data
Apr. 30, 2021 (EP) 21171695.6

(51) Int. Cl. C04B 40/00; C04B 14/06; C04B 14/34; C04B 22/00; C04B 22/06; C04B 22/10; C04B 22/14; C04B 24/12; C04B 103/14; C04B 111/00

(52) U.S. Cl. CPC C04B 40/0039; C04B 14/06; C04B 14/34; C04B 22/0093; C04B 22/064; C04B 22/106; C04B 22/148; C04B 24/122; C04B 2103/14; C04B 2111/00172

(57) ABSTRACT

A soluble alkali metal compound for adjusting, in particular reducing, the viscosity of an aluminum sulfate suspension, the alkali metal being selected from among sodium, potassium and/or lithium.

### TECHNICAL FIELD

The invention relates to compositions for adjusting, more particularly for reducing, the viscosity of an aluminum sulfate suspension. The invention further relates to an aluminum sulfate suspension.

### PRIOR ART

There are many known substances that accelerate the solidification and hardening of mineral binder compositions. Known examples include strongly alkaline substances, such as alkali metal hydroxides, alkali metal carbonates, alkali metal silicates, alkali metal aluminates and alkaline earth metal chlorides.

It is however mainly alkali-free accelerators that are used, accelerators based on aluminum sulfate suspensions being among those that have been found to be particularly effective and to have a good price/performance relationship. However, a problem with such accelerators is that the viscosities of the accelerators increase significantly with increasing active substance content. Among other things, this complicates production, the exact metered addition of the accelerators, and miscibility with the mineral binder compositions to be accelerated.

WO 2005/075381 A1 describes, for example, a solidification and hardening accelerator comprising aluminum hydroxide, aluminum sulfate, and organic acid, wherein the accelerator has a molar ratio of aluminum to organic acid of less than 0.65.

EP 0 812 812 B1 discloses alkali-free accelerator dispersions based on aluminum sulfate and an alkanolamine in the absence of aluminum hydroxide.

However, large amounts of acids and alkanolamines have the disadvantage that their leachability can cause pollution of the environment. They are also disadvantageous on account of their cost.

EP 1 878 713 A1 (Construction Research and Technology GmbH) describes an accelerator for spray concrete or spray mortar in the form of an aqueous dispersion containing 25% to 40% by weight of aluminum sulfate and aluminum hydroxide, in which the molar ratio of aluminum to sulfate in the dispersion is 1.35 to 0.70. The aqueous dispersion also includes an inorganic stabilizer comprising a magnesium silicate in the form of sepiolite. If sepiolite is used in a proportion of 0.2-3% by weight, the result according to EP 1 878 713 A1 is not only stabilization of the dispersion over wide ranges of the intended amounts of aluminum and sulfate but also an advantageous viscosity in the spray concrete accelerator.

However, a disadvantage of such accelerators is that achievement of the high active substance content requires addition of additional aluminum hydroxide and raising of the ratio of aluminum to sulfate, which is undesirable in some cases. The effect of this is that the costs for the accelerator are relatively high, since aluminum hydroxide is costly. Moreover, although the magnesium silicate used as stabilizer, in the form of sepiolite, is a very good stabilizer for spray concrete accelerators, sepiolite has been found to be ineffective in reducing viscosity. On the contrary, the addition of sepiolite immediately after production always leads to an increase in the viscosity of the aluminum sulfate suspension.

This means that although the aluminum sulfate suspensions can be stabilized at relatively high active substance content, it is not possible to positively influence or control the viscosities of such aluminum sulfate suspensions, especially immediately after production.

In the as-yet unpublished patent application EP 19207659.4 of the applicant, it is shown that a reduction in the viscosity of aluminum sulfate suspensions can in some cases be achieved by the addition of magnesium compounds.

For reducing viscosity there is however still a demand for solutions having improved efficacy and also for more inexpensive solutions.

There is therefore still a need for new and improved solutions that overcome the aforementioned drawbacks as far as possible.

### SUMMARY OF THE INVENTION

It is an object of the invention to provide solutions that enable the production of aluminum sulfate suspensions having the highest possible aluminum sulfate content with the lowest possible viscosity. More particularly, a low viscosity is achieved immediately after the addition of a soluble alkali metal compound to the aluminum sulfate suspension and a low viscosity is preferably maintained even at later points in time after the addition of a soluble alkali metal compound to the aluminum sulfate suspension. This is in particular achieved without it influencing the ratio of aluminum to sulfate and preferably without adversely affecting the efficacy of other components of the aluminum sulfate suspension. The aluminum sulfate suspensions should in particular be suitable as a very effective solidification accelerator and/or hardening accelerator for a composition comprising a mineral binder, in particular for spray concrete or spray mortar, the aluminum sulfate suspension being suitable as a spray concrete accelerator in particular. The solutions are additionally to be implementable in a very inexpensive and simple manner.

It has been found that, surprisingly, the object of the invention is achieved by the use as claimed in claim 1.

Accordingly, at least one soluble alkali metal compound is used for adjusting, more particularly for reducing, the viscosity of an aluminum sulfate suspension, wherein the alkali metal is selected from sodium, potassium and/or lithium.

As has been shown, the use of a soluble alkali metal compound can significantly reduce the viscosity of an aluminum sulfate suspension for the same aluminum sulfate content and/or markedly increase the aluminum sulfate content for the same viscosity. It is thus possible in a simple manner to produce relatively inexpensive aluminum sulfate suspensions having a high content of aluminum sulfate allied with relatively low viscosity that are particularly suitable as solidification accelerators and hardening accelerators for spray concrete and spray mortar.

The use of the at least one soluble alkali metal compound is in particular effective in reducing the viscosity of the aluminum sulfate suspension within a period of 1-48 h, preferably 1-24 h or 1-12 h, more particularly 2-6 h, after addition to the aluminum sulfate suspension or after all the components for producing the aluminum sulfate suspension have been mixed together. A particular advantage is that viscosity spikes, as can occur in the first hours after the production of aluminum sulfate suspensions, are attenuated, which is an advantage for economic production.

Moreover, it has been shown that the soluble alkali metal compound is effective as an agent for adjusting, more particularly for reducing, and/or for maintaining the viscosity even at later points in time, more particularly 1-3 months after addition to the aluminum sulfate suspension. This is the case particularly in aluminum sulfate suspensions having a proportion of >34% by weight of aluminum sulfate (Al₂(SO₄)₃).

The use of an appropriately selected soluble alkali metal compound allows a change in the ratio of aluminum to sulfate to be avoided. With the use of alkali metal aluminates it is however also possible to increase the Al content in the suspension, which is usually, but not always, advantageous.

The alkali metal compounds of Na, K, and Li are able to show better efficacy than magnesium compounds. Moreover, compounds of Na and K are inexpensive by comparison with other chemicals, thus achieving an excellent price/performance relationship. Problems due to precipitation at high concentrations, as can occur for example when using magnesium compounds (precipitation of magnesium sulfate), do not arise.

The soluble alkali metal compound can also be combined directly with conventional and stabilizing magnesium silicates, especially with sepiolite, without adversely affecting the efficacy of the soluble alkali metal compound. For instance, in an aluminum sulfate suspension, if required it is possible, for example, to use a magnesium silicate, especially sepiolite, in combination with the soluble alkali metal compound, by means of which particularly stable aluminum sulfate suspensions having high active substance content and low viscosity are obtainable.

In addition, if required it is possible to dispense with potentially problematic and/or costly substances such as alkanolamines, carboxylic acids, and aluminum hydroxide. This can be done without a significant loss of accelerating action.

Further aspects of the invention are the subject of further independent claims. Particularly preferred embodiments of the invention are the subject of the dependent claims.

### Ways of Executing the Invention

In a first aspect, the invention relates to the use of at least one soluble alkali metal compound for adjusting, more particularly for reducing, the viscosity of an aluminum sulfate suspension, wherein the alkali metal is selected from sodium, potassium and/or lithium. Mixtures of two or more soluble alkali metal compounds may be used, but the use of just one alkali metal compound is generally preferred for practical reasons.

An “aluminum sulfate suspension” is a heterogeneous substance mixture composed of a liquid, more particularly water, and particles of aluminum sulfate finely dispersed therein. It is preferably an aqueous aluminum sulfate suspension. As well as the aluminum sulfate in particle form, some of the aluminum sulfate may also be in dissolved and/or chemically modified form, more particularly in the aqueous aluminum sulfate suspension. An example of a chemically modified form of aluminum sulfate is jurbanite (AlOHSO₄·5H₂O). An aluminum sulfate suspension is in the present context not a pure solution; rather, there are always finely dispersed particles of aluminum sulfate in the liquid phase, more particularly water. In addition to the liquid and the aluminum sulfate, the aluminum sulfate suspension may contain further components that may be in dissolved and/or solid form.

The aluminum sulfate suspension is particularly preferably a solidification accelerator and/or hardening accelerator for a mineral binder, especially a spray concrete accelerator. Correspondingly, the soluble alkali metal compound is preferably used for adjusting the viscosity of a solidification accelerator and/or hardening accelerator based on an aluminum sulfate suspension for a composition containing a mineral binder, especially cement, wherein the aluminum sulfate suspension is preferably a spray concrete accelerator, for spray concrete or spray mortar in particular.

The expression “solidification accelerator and/or hardening accelerator” more particularly represents a substance which, when a mineral binder is added and compared to a blank sample without added substance/without accelerator, results in an increase in the compressive strength of the mineral binder after a defined time after mixing, more particularly at a time within 2 minutes to 24 hours after mixing.

A “soluble alkali metal compound” is in the present context an alkali metal compound that is soluble to an extent of at least 5 g per 1 liter in distilled water adjusted to pH 2 with HCl, at 25° C. and a pressure of 1 bar.

What is meant more particularly by “adjusting the viscosity” is in the present context that the viscosity of the aluminum sulfate suspension is controlled and/or adjusted by the soluble alkali metal compound. More particularly, the presence of the soluble alkali metal compound alters or reduces the viscosity of the aluminum sulfate suspension compared to that of an aluminum sulfate suspension that does not contain the soluble alkali metal compound but is otherwise of identical composition.

The viscosity is more particularly determined according to standard DIN EN ISO 2431:2011. This is preferably done with an ISO No. 6 or No. 4 cup and at a temperature of 23° C.

Proportions by weight and molar proportions are, unless otherwise stated, in each case based on the ready-to-use aluminum sulfate suspension after adjustment of the viscosity. The ready-to-use aluminum sulfate suspension is more particularly designed for direct use as a solidification accelerator and/or hardening accelerator. The ready-to-use aluminum sulfate suspension thus also includes, besides the aluminum sulfate and the liquid, at least one soluble alkali metal compound and optionally further components present.

The aluminum sulfate suspension is preferably chloride-free. The aluminum sulfate suspension is also preferably alkali-free or low in alkali, despite use of the alkali metal compound.

What is typically meant by alkali-free in construction chemistry is a composition having less than 1% by weight of alkali metal ions and/or alkaline earth metal ions calculated as sodium oxide equivalent (Na₂O), based on the total weight of the composition or of the aluminum sulfate suspension. What is meant by low in alkali here is a composition having not more than 5% by weight of alkali metal ions and/or alkaline earth metal ions calculated as sodium oxide equivalent (Na₂O), based on the total weight of the composition or of the aluminum sulfate suspension.

Na₂O equivalent refers to the resulting amount by weight if all alkali metal ions (especially Na and K) were present as Na₂O.

What is typically meant by chloride-free in construction chemistry is a composition having less than 0.1% by weight of chloride ions, based on the total weight of the composition or of the aluminum sulfate suspension.

The soluble alkali metal compound is used more particularly for adjusting the viscosity, more particularly for reducing the viscosity.

More particularly, the soluble alkali metal compound is used for adjusting the viscosity, more particularly for reducing the viscosity, of an aluminum sulfate suspension, the adjustment of the viscosity, more particularly the reduction, preferably being concluded within a period of 1-168 h, more preferably 1-48 h, especially within a period of 1-24 h, after the aluminum sulfate suspension with the added soluble alkali metal compound has been obtained. In particular, the soluble alkali metal compound is able to reduce the viscosity of an aluminum sulfate suspension within a period of 1-6 h after the addition to the aluminum sulfate suspension or after all the components for producing the aluminum sulfate suspension have been mixed, which is an advantage for production in particular.

In particular, once the viscosity has been adjusted, it remains stable over a prolonged period, more particularly over a period of several months. The soluble alkali metal compound is therefore used especially for adjusting the viscosity, more particularly for reducing the viscosity, of an aluminum sulfate suspension over a period of several months, very particularly preferably 1-3 months, after the aluminum sulfate suspension with the added soluble alkali metal compound has been obtained. This is the case particularly for aluminum sulfate suspensions having a proportion of >34% by weight of aluminum sulfate (Al₂(SO₄)₃).

Since the soluble alkali metal compound enables adjustment of the viscosity, more particularly reduction of the viscosity, within a period of 1-168 h, preferably 1-48 h, especially within a period of 6-24 h, after the aluminum sulfate suspension with the added soluble alkali metal compound has been obtained, the viscosity of the aluminum sulfate suspension can be adjusted to the desired value even shortly after production. This in turn permits a shorter production time, since the aluminum sulfate suspensions can be used as intended within a few hours after production, more particularly as solidification accelerator and/or hardening accelerator.

Since the soluble alkali metal compound additionally enables adjustment of the viscosity, more particularly reduction of the viscosity, over a prolonged period, more particularly over a period of several months, after the aluminum sulfate suspension with the added soluble alkali metal compound has been obtained, it is possible to achieve a long-term reduction in viscosity. It is thus possible to store the aluminum sulfate suspensions with essentially constant viscosity over a prolonged period if required.

The soluble alkali metal compound can accordingly be used in a method for adjusting the viscosity of an aluminum sulfate suspension.

A further aspect of the present invention is accordingly a method for adjusting the viscosity, more particularly reducing the viscosity, of an aluminum sulfate suspension, preferably within a period of 1-168 h, preferably 1-48 h, especially within a period of 6-24 h, after the aluminum sulfate suspension with the added soluble alkali metal compound has been obtained, and/or for adjusting the viscosity, more particularly reducing the viscosity, over a prolonged period, more particularly over a period of several months, comprising the steps of:
a) initially charging an aqueous preparation of aluminum sulfate and
b) mixing in at least one soluble alkali metal compound
c) optionally mixing in further aluminum sulfate, to obtain an aluminum sulfate suspension,
or
a) initially charging an aqueous preparation of a soluble alkali metal compound and b) mixing in aluminum sulfate to obtain an aluminum sulfate suspension.

All variants are possible. In some cases, alternating addition of the individual components is a preferred method. A preparation is in the present context a solution or suspension. An aqueous preparation is accordingly a solution or suspension in water.

The aqueous preparation of aluminum sulfate is a solution or suspension of aluminum sulfate in water. It is also possible that proportions of aluminum sulfate in dissolved form and proportions of aluminum sulfate in suspended form are present in the aqueous preparation.

The inventive solidification and/or hardening accelerators for compositions comprising hydraulic binders, in particular for spray concrete or spray mortar, are aluminum sulfate suspensions.

The soluble alkali metal compound can be added directly to the aluminum sulfate preparation during the production thereof. It is however also possible to add the soluble alkali metal compound to the aluminum sulfate preparation shortly after the production thereof, for example within 1 h after the production thereof. Lastly, it is also possible to add the soluble alkali metal compound to the aluminum sulfate preparation only after a prolonged period after the production thereof, for example after 5 days or longer.

The soluble alkali metal compound is preferably a basic alkali metal compound. This means that the soluble alkali metal compound is capable of raising the pH of distilled water that has been adjusted to pH 2 with HCl at 25° C. and a pressure of 1 bar when it is added to the acidified water.

The soluble alkali metal compound preferably comprises an alkali metal salt and/or an alkali metal complex.

The soluble alkali metal compounds used in accordance with the invention permit the formulation of highly effective solidification and/or hardening accelerators that are essentially free of calcium. Since calcium can sometimes slow the reaction or dissolution of cement clinkers, a solidification and/or hardening accelerator essentially free of calcium may be advantageous.

The alkali metal of the alkali metal compound is selected from sodium, potassium and/or lithium, preference being given to sodium and/or potassium.

In particular, the soluble alkali metal compound is an aluminate, oxide, hydroxide, carbonate, hydrogen carbonate, nitrate, sulfate, phosphate, halide, formate, acetate, citrate, thiocyanate, silicate or mixtures thereof.

Further preferably, the soluble alkali metal compound is an aluminate, oxide, hydroxide, carbonate, hydrogen carbonate, nitrate, formate, acetate, citrate or mixtures thereof.

Preferably, the soluble alkali metal compound is a sodium aluminate, sodium carbonate, sodium bicarbonate, sodium oxide, sodium hydroxide, potassium aluminate, potassium carbonate, potassium bicarbonate, potassium oxide, potassium hydroxide, lithium aluminate, lithium carbonate, lithium bicarbonate, lithium oxide, lithium hydroxide or a mixture thereof, the sodium or potassium compounds being preferred. Very particularly preferably, the alkali metal compound is selected from sodium aluminate, sodium carbonate, sodium bicarbonate, sodium oxide, sodium hydroxide, potassium aluminate or a mixture thereof.

These alkali metal compounds have been found to be particularly advantageous in the present context since they make it possible to achieve a significant reduction in viscosity without adversely affecting further components. Moreover, the substances are of good availability.

In principle, it is however also possible to use other soluble alkali metal compounds.

The at least one soluble alkali metal compound, more particularly the soluble alkali metal compounds mentioned above, may be added to the aluminum sulfate suspension or during the production of the aluminum sulfate suspension for example in powder form or as an aqueous solution. Sodium aluminate may be added for example as a powder or as an aqueous solution.

The amount of the soluble alkali metal compound is preferably chosen such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight.

These amounts enable a particularly good reduction in viscosity without appreciable adverse effect on the solidification accelerator and/or hardening accelerator properties of the aluminum sulfate suspension.

The aluminum sulfate suspension, based on the total weight of the aluminum sulfate suspension, preferably has a proportion of sulfate (SO₄⁻) of 19-40% by weight, more particularly 24-36% by weight, especially 28-34% by weight.

It is further preferable when the aluminum sulfate suspension, based on the total weight of the aluminum sulfate suspension, has a proportion of aluminum (Al) of 3.5-10% by weight, more particularly 4.5-8.7% by weight, in particular 5.4-7% by weight.

With such proportions of aluminum and sulfate it is possible to produce aluminum sulfate suspensions having a high active substance content that exhibit particularly good acceleration of solidification and/or hardening.

The aluminum sulfate suspension advantageously comprises aluminum sulfate, aluminum hydroxide sulfate, sulfuric acid, aluminum hydroxide and/or aluminum hydroxide carbonate. Particular preference is given to aluminum sulfate.

The sulfate in the aluminum sulfate suspension originates especially from aluminum sulfate, aluminum hydroxide sulfate and/or sulfuric acid. Particular preference is given to aluminum sulfate. In other words, the accelerator more particularly contains at least one of the substances mentioned as source for sulfate.

The aluminum in the accelerator originates advantageously from aluminum sulfate, aluminum hydroxide sulfate, aluminum hydroxide and/or aluminum hydroxide carbonate. Particular preference is given to aluminum sulfate. In other words, the accelerator more particularly contains at least one of the substances mentioned as source for aluminum.

In an advantageous embodiment, the aluminum sulfate suspension, based on the total weight of the aluminum sulfate suspension, contains 22-46% by weight, more particularly 28-43% by weight, preferably 34-41% by weight, of aluminum sulfate (Al₂(SO₄)₃).

The aluminum sulfate usable for the production may especially contain varying amounts of water of crystallization. The aluminum sulfate typically used is aluminum sulfate tetradecahydrate (Al₂(SO₄)₃·approx. 14H₂O). It is typically referred to also as 17% aluminum sulfate, since it contains approx. 17% Al₂O₃.

The stated amounts relating to aluminum sulfate that are mentioned in the present document are, unless otherwise stated, in each case based on Al₂(SO₄)₃ without water of crystallization. The stated amounts for the various reference compounds can easily be converted with reference to the following relationships: Al₂(SO₄)₃·approx. 14H₂O contains 57% by weight of Al₂(SO₄)₃ or 17% by weight of Al₂O₃.

The aluminum sulfate may also be produced by a reaction of aluminum hydroxide and/or aluminum metal with sulfuric acid during production of the aluminum sulfate suspension, with corresponding formation of sulfate ions in the aqueous solution. In general, aluminum sulfate can be produced by a reaction of a basic aluminum compound and/or aluminum metal with sulfuric acid.

In a further advantageous embodiment, the aluminum sulfate suspension, based on the total weight of the aluminum sulfate suspension, contains 0.01-15% by weight, more particularly 0.05-5% by weight, particularly preferably 0.1-2% by weight, of aluminum hydroxide.

It is thus possible, for example, to increase the aluminum content independently of the sulfate content of the aluminum sulfate suspensions in an effective manner.

The aluminum hydroxide may be used in amorphous and/or crystalline form. It is advantageous when amorphous aluminum hydroxide is used. This is especially because crystalline aluminum hydroxide typically reacts sufficiently only at temperatures of >130° C. and a pressure of >1 bar. The aluminum hydroxide may also be used in the form of aluminum hydroxide carbonate, aluminum hydroxide sulfate or the like.

In an advantageous embodiment the molar ratio of aluminum to sulfate in the aluminum sulfate suspension is less than or equal to 0.9, preferably less than or equal to 0.85, more preferably less than or equal to 0.8, even more preferably less than or equal to 0.74, very particularly preferably less than or equal to 0.7, in particular 2:3. In this case, the aluminum sulfate suspension can be produced in a particularly simple manner by suspending aluminum sulfate (Al₂(SO₄)₃). In the inventive use of the soluble alkali metal compound, it is thus possible to produce aluminum sulfate suspensions having high active substance contents and low viscosities.

In a further advantageous embodiment, the molar ratio of aluminum to sulfate in the aluminum sulfate suspension is in the range of 0.5-2, preferably 0.67-1.35, in particular 0.7-1.0. Such aluminum sulfate suspensions have improved efficacy for certain applications.

The aluminum sulfate suspension, based on the total weight of the aluminum sulfate suspension, preferably has a proportion of water of 30-80% by weight, more particularly 40-70% by weight, preferably 50-65% by weight. Water of crystallization in the components of the aluminum sulfate suspension, for example water of crystallization from aluminum sulfate, is included in the calculation here.

In a further advantageous embodiment, the soluble alkali metal compound is used for reducing viscosity in combination with a magnesium compound, a calcium compound and/or an iron compound. In particular, both a calcium compound and an iron compound are used. Without being bound by any particular theory, it is assumed that the calcium compound and the iron compound additionally enhance the effect of the soluble alkali metal compound. In an especially preferred embodiment, the soluble alkali metal compound for reducing the viscosity of the aluminum sulfate suspension is used in combination with a magnesium compound.

The magnesium compound, calcium compound and/or iron compound is in particular an oxide, hydroxide, carbonate, nitrate, sulfate, phosphate, halide, formate, acetate and/or citrate.

The magnesium compound, calcium compound and/or iron compound is preferably an oxide, hydroxide, carbonate, nitrate, formate, acetate and/or citrate.

The calcium compound is particularly preferably a calcium carbonate, a calcium oxide and/or a calcium hydroxide. Particular preference is given to calcium oxide. The magnesium compound is particularly preferably a magnesium carbonate, a magnesium oxide and/or a magnesium hydroxide.

The calcium compound is especially Ca(OH)₂, CaCO₃ and/or CaO. Particular preference is given to CaO. The magnesium compound is especially Mg(OH)₂, MgCO₃ and/or MgO. Particular preference is given to MgO.

An amount of the calcium compound or magnesium compound is in particular chosen such that the calcium atoms or magnesium atoms, based on the total weight of the aluminum sulfate suspension, have a proportion of 0.001-4% by weight, preferably 0.01-2% by weight, more particularly 0.07-1.4% by weight, especially 0.1-0.7% by weight.

If CaO is used as a calcium compound, a proportion of CaO, based on the total weight of the aluminum sulfate suspension, is advantageously 0.001-5% by weight, preferably 0.01-3% by weight, more particularly 0.1-2% by weight, especially 0.2-1% by weight. If MgO is used as a magnesium compound, a proportion of MgO, based on the total weight of the aluminum sulfate suspension, is advantageously 0.001-5% by weight, preferably 0.01-3% by weight, more particularly 0.1-2% by weight, especially 0.2-1% by weight.

The iron compound is particularly preferably an iron oxide. The iron compound is especially Fe₂O₃.

An amount of the iron compound is in particular chosen such that the iron atoms, based on the total weight of the aluminum sulfate suspension, have a proportion of 0.001-10% by weight, more particularly 0.1-5% by weight, especially 0.2-2% by weight, very particularly preferably 0.1-0.6% by weight.

If Fe₂O₃ is used as the iron compound, a proportion of Fe₂O₃, based on the total weight of the aluminum sulfate suspension, is advantageously 0.001-14.3% by weight, more particularly 0.1-7.1% by weight, especially 0.2-2% by weight.

In a further advantageous embodiment, the aluminum sulfate suspension contains silica.

The term “silica” in the present document means a silica that includes not just orthosilicic acid but also all forms of silicon dioxide, i.e. the anhydride of orthosilicic acid, actual silicon dioxide, and also colloidal, precipitated or fumed silica or silica fume. The silica is preferably silicon dioxide or SiO₂.

The silica is preferably present in an amount such that the content of silicon dioxide, based on the total weight of the aluminum sulfate suspension, is 0.001% to 5% by weight, preferably 0.1% to 2% by weight, even more preferably 0.2% to 1% by weight.

In addition, for the production of the aluminum sulfate suspension it is possible to use at least one further divalent or higher-valency metal salt, more particularly a metal sulfate, preferably in an amount of 0.1-5% by weight, based on the total weight of the aluminum sulfate suspension. A particularly preferred further metal sulfate is manganese(II) sulfate. Iron sulfate is likewise suitable.

It may further be advantageous when the aluminum sulfate suspension additionally contains 0.1-15% by weight, preferably 0.1-5% by weight, especially 0.2-2% by weight, based on the total weight of the aluminum sulfate suspension, of an alkanolamine. The alkanolamine used is advantageously monoethanolamine, diethanolamine, triethanolamine and/or methyldiisopropanolamine.

The aluminum sulfate suspension may additionally contain stabilizers, for example bentonite, palygorskite (for example Actigel 208), kaolin and/or magnesium silicates, for example sepiolite. It is preferable that aluminum sulfate suspensions of the invention are free of organic plasticizers, especially of polycarboxylates, polycarboxylate esters and/or polycarboxylate ethers.

The aluminum sulfate suspension may especially contain a magnesium silicate, especially a sheet silicate and/or phyllosilicate, for example sepiolite and/or bentonite. If present, a proportion of magnesium silicate is advantageously 0.001-5% by weight, preferably 0.1-2% by weight, especially 0.2-1% by weight, based on the total weight of the aluminum sulfate suspension. Magnesium silicates in the present context are inert, or insoluble according to the above definition of solubility, and contribute to phase stabilization.

In addition, the soluble alkali metal compound may be used in combination with a magnesium silicate for adjusting, more particularly for reducing, viscosity and for simultaneous stabilization of the aluminum sulfate suspension. The magnesium silicate may especially be a sheet silicate and/or phyllosilicate, for example sepiolite and/or bentonite. Particular preference is given to sepiolite. The magnesium silicate, especially sepiolite, is preferably used in a proportion of 0.001-5% by weight, preferably 0.1-2% by weight, especially 0.2-1% by weight, based on the total weight of the aluminum sulfate suspension. The amount of the soluble alkali metal compound is preferably chosen such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight.

The aluminum sulfate suspension may of course comprise further constituents. These may in particular be fluorine compounds, for example hydrofluoric acid, alkali metal fluorides and/or fluoro complexes. These enable, for example, further enhancement of the accelerating action.

In particular, the aluminum sulfate suspension, based on the total weight of the aluminum sulfate suspension, contains 0.01-10% by weight, more particularly 0.05-2% by weight, preferably 0.1-0.5% by weight, of fluoride. This can potentially enhance the accelerating action of the aluminum sulfate suspension.

The aforementioned substances are more particularly at least partly present as ions in solution. However, they may for example also occur in complexed or undissolved form in the aluminum sulfate suspension.

A particularly advantageous aluminum sulfate suspension comprises for example the following components or consists thereof (in % by weight, in each case based on the total weight of the aluminum sulfate suspension):
a) 19% to 40% by weight, more particularly 24-36% by weight, especially 28-34% by weight, of sulfate;
b) 3.5-10% by weight, more particularly 4.5-8.7% by weight, in particular 5.4-7% by weight, of aluminum;
c) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight;
d) optionally 0.001-4% by weight, preferably 0.01-2% by weight, more particularly 0.07-1.4% by weight, especially 0.1-0.7% by weight, of calcium or magnesium;
e) optionally 0.001-10% by weight, more particularly 0.1-5% by weight, especially 0.2-2% by weight, very particularly preferably 0.1-0.6% by weight, of iron;
f) optionally 0.001% to 5% by weight, preferably 0.1% to 2% by weight, even more preferably 0.2% to 1% by weight, of silicon dioxide or SiO₂;
g) and water, where the proportion missing from 100% by weight is preferably water, particularly preferably 30-77.48% by weight, more particularly 40-70% by weight, very particularly preferably 50-65% by weight, of water.

A particularly preferred aluminum sulfate suspension contains for example (in % by weight, in each case based on the total weight of the aluminum sulfate suspension):
a) 22-46% by weight, more particularly 28-43% by weight, preferably 34-41% by weight, of aluminum sulfate (Al₂(SO₄)₃;
b) optionally 0.01-15% by weight, more particularly 0.05-5% by weight, particularly preferably 0.1-2% by weight, of aluminum hydroxide (Al(OH)₃);
c) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight;
d) optionally 0.001-5% by weight, more particularly 0.1-2% by weight, especially 0.2-1% by weight, of a calcium compound selected from calcium oxide and/or calcium hydroxide or of a magnesium compound selected from magnesium oxide and/or magnesium hydroxide;
e) optionally 0.001-10% by weight, more particularly 0.1-5% by weight, especially 0.2-2% by weight, very particularly preferably 0.1-0.6% by weight, of iron; f) optionally 0.001% to 5% by weight, preferably 0.1% to 2% by weight, even more preferably 0.2% to 1% by weight, of silicon dioxide;
g) optionally 0.1-15% by weight, preferably 0.1-5% by weight, especially 0.2-2% by weight, of alkanolamine;
h) 0.01-10% by weight, more particularly 0.05-2% by weight, preferably 0.1-0.5% by weight, of fluoride;
i) and water, where the proportion missing from 100% by weight is preferably water.

In a preferred embodiment, the most preferred ranges and substances in each case are chosen.

In an especially preferred embodiment, the aluminum sulfate suspension comprises for example the following components, or consists thereof (in % by weight, in each case based on the total weight of the aluminum sulfate suspension):
a) 34-41% by weight of aluminum sulfate (Al₂(SO₄)₃;
b) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight;
c) 0.2-1% by weight of a calcium compound selected from calcium oxide and/or calcium hydroxide or of a magnesium compound selected from magnesium oxide and/or magnesium hydroxide;
d) optionally 0.001-14.3% by weight, more particularly 0.1-7.1% by weight, especially 0.2-2% by weight, of iron oxide;
e) optionally 0.001% to 5% by weight, preferably 0.1% to 2% by weight, even more preferably 0.2% to 1% by weight, of silicon dioxide;
f) and water, where the proportion missing from 100% by weight is preferably water.

In a further, especially preferred embodiment, the aluminum sulfate suspension comprises for example the following components, or consists thereof (in % by weight, in each case based on the total weight of the aluminum sulfate suspension):
a) 34-41% by weight of aluminum sulfate (Al₂(SO₄)₃;
b) at least one alkali metal aluminate as at least one soluble alkali metal compound, especially sodium aluminate and/or potassium aluminate, in an amount such that the alkali metal atoms, based on the total weight of the aluminum sulfate suspension, have a proportion of 0.02-5% by weight, more particularly 0.05-2% by weight, particularly preferably 0.1-1.4% by weight, especially 0.2-0.7% by weight;
c) optionally 0.001-5% by weight, more particularly 0.1-2% by weight, especially 0.2-1% by weight, of a calcium compound selected from calcium oxide and/or calcium hydroxide or of a magnesium compound selected from magnesium oxide and/or magnesium hydroxide;
d) optionally 0.001-5% by weight, more particularly 0.1-2% by weight, especially 0.2-1% by weight, of iron oxide;
e) optionally 0.001% to 5% by weight, preferably 0.1% to 2% by weight, even more preferably 0.2% to 1% by weight, of silicon dioxide;
f) and water, where the proportion missing from 100% by weight is preferably water.

A further aspect of the present invention relates to a process for producing an aluminum sulfate suspension as described above that is more particularly designed as a setting and/or hardening accelerator. The aforementioned components or substances are more particularly mixed to give an aqueous suspension. The individual substances can in principle be added in any order. The aluminum sulfate suspensions are correspondingly obtainable by processes of this kind.

The aluminum sulfate suspensions obtainable in accordance with the invention may be used as solidification and/or hardening accelerators for accelerating the setting and/or hardening of mineral binders and/or mineral binder compositions. The composition is especially a mortar and/or concrete composition, especially a spray mortar and/or a spray concrete.

The expression “mineral binder” is more particularly understood to mean a binder that reacts in the presence of water in a hydration reaction to form solid hydrates or hydrate phases. This may for example be a hydraulic binder (for example cement or hydraulic lime), a latently hydraulic binder (for example slag), a pozzolanic binder (for example fly ash) or a nonhydraulic binder (gypsum or white lime). A “mineral binder composition” is correspondingly a composition containing at least one mineral binder.

Examples of mineral binders, the hardening and/or setting of which can be accelerated by the aluminum sulfate suspensions of the invention, are cements, for example portland cement, mixed cements, alumina cements, calcium sulfoaluminate cements, and lime, hydraulic lime and gypsum, or mixtures of two or more of the mineral binders mentioned.

More particularly, the mineral binder or the binder composition comprises a hydraulic binder, preferably cement. Particular preference is given to a cement having a cement clinker content of >35% by weight; more particularly the cement is CEM type I, II, III, IV or V (according to standard EN 197-1). A proportion of the hydraulic binder in the total mineral binder is advantageously at least 5% by weight, more particularly at least 20% by weight, preferably at least 35% by weight, especially at least 65% by weight. In a further advantageous embodiment, the mineral binder consists to an extent of at least 95% by weight of hydraulic binder, especially of cement clinker.

It may however also be advantageous when the binder composition contains other binders in addition or in place of a hydraulic binder. These are especially latently hydraulic binders and/or pozzolanic binders. Examples of suitable latently hydraulic and/or pozzolanic binders are slag, fly ash and/or silica dust. The binder composition may likewise comprise inert substances, for example ground limestone, ground quartz and/or pigments.

In an advantageous embodiment, the mineral binder contains 5-95% by weight, more particularly 5-65% by weight, especially 15-35% by weight, of latently hydraulic and/or pozzolanic binders.

The present invention further relates to a method for accelerating the solidifying and/or hardening of mineral binders or mineral binder compositions, for example mortar or concrete, wherein an above-described aluminum sulfate suspension is added to a mineral binder or a mineral binder composition as a solidification and/or hardening accelerator in an amount of 0.1% to 15% by weight, more particularly of 1% to 10% by weight, particularly preferably 4-8% by weight, based on the weight of the mineral binder.

For example, it is possible to add the aluminum sulfate suspension to a concrete or mortar composition, especially to a spray concrete or a spray mortar, with use of the concrete or mortar composition for coating of a substrate. The substrate is especially a surface of a tunnel, of a mine, of an excavation, of a bay, of a well and/or of a drain.

The aluminum sulfate suspension is preferably metered into a spray mortar or spray concrete by the dry or wet spraying method, with addition of the aluminum sulfate suspension to the dry or water-mixed binder, spray mortar or spray concrete in the conveying conduit, the pre-wetting nozzle or the spray nozzle. Addition of the aluminum sulfate suspension at the concrete works is also possible.

It is also possible to add the aluminum sulfate suspension to a concrete or mortar composition, especially to a spray concrete or a spray mortar, with use of the concrete or mortar composition for the production of free-form structures.

In addition, it is possible to mix the aluminum sulfate suspension into a concrete or mortar composition in an additive manufacturing process, preferably by means of a dynamic mixer.

The present invention relates also to a solidification accelerator and/or hardening accelerator for a composition comprising a mineral binder, wherein the solidification accelerator and/or hardening accelerator is preferably a spray concrete accelerator, and wherein the solidification accelerator and/or hardening accelerator comprises: a) 22-46% by weight, more particularly 28-43% by weight, preferably 34-41% by weight, of aluminum sulfate (Al₂(SO₄)₃;
b) optionally 0.01-15% by weight, more particularly 0.05-5% by weight, particularly preferably 0.1-2% by weight, of aluminum hydroxide (Al(OH)₃);
c) optionally 0.001-5% by weight, more particularly 0.1-2% by weight, especially 0.2-1% by weight, of a calcium compound selected from calcium oxide and/or calcium hydroxide or of a magnesium compound selected from magnesium oxide and/or magnesium hydroxide;
d) optionally 0.001-10% by weight, more particularly 0.1-5% by weight, especially 0.2-2% by weight, very particularly preferably 0.1-0.6% by weight, of iron;
e) optionally 0.001% to 5% by weight, preferably 0.1% to 2% by weight, even more preferably 0.2% to 1% by weight, of silicon dioxide;
f) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight, more particularly 0.05-3% by weight, particularly preferably 0.1-1.4% by weight, especially 0.2-0.7% by weight;
g) optionally 0.1-15% by weight, preferably 0.1-5% by weight, especially 0.2-2% by weight, of alkanolamine;
h) optionally 0.01-10% by weight, more particularly 0.05-2% by weight, preferably 0.1-0.5% by weight, of fluoride;
i) and water, where the proportion missing from 100% by weight is preferably water.

Such solidification accelerators and/or hardening accelerators preferably have a mass ratio of alkali metal atoms to aluminum sulfate (Al₂(SO₄)₃) of from 1 mg/g to 100 mg/g.

An advantageous solidification accelerator and/or hardening accelerator for a composition comprising a mineral binder, wherein the solidification accelerator and/or hardening accelerator is preferably a spray concrete accelerator, comprises:
a) 22-46% by weight, more particularly 28-43% by weight, preferably 34-41% by weight, of aluminum sulfate (Al₂(SO₄)₃,
b) optionally 0.01-15% by weight, more particularly 0.05-5% by weight, particularly preferably 0.1-2% by weight, of aluminum hydroxide (Al(OH)₃);
c) optionally 0.001-5% by weight, more particularly 0.1-2% by weight, especially 0.2-1% by weight, of a calcium compound selected from calcium oxide and/or calcium hydroxide or of a magnesium compound selected from magnesium oxide and/or magnesium hydroxide;
d) optionally 0.001-10% by weight, more particularly 0.1-5% by weight, especially 0.2-2% by weight, very particularly preferably 0.1-0.6% by weight, of iron;
e) optionally 0.001% to 5% by weight, preferably 0.1% to 2% by weight, even more preferably 0.2% to 1% by weight, of silicon dioxide;
f) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight, more particularly 0.05-3% by weight, particularly preferably 0.1-1.4% by weight, especially 0.2-0.7% by weight;
g) optionally 0.1-15% by weight, preferably 0.1-5% by weight, especially 0.2-2% by weight, of alkanolamine;
h) optionally 0.01-10% by weight, more particularly 0.05-2% by weight, preferably 0.1-0.5% by weight, of fluoride;
and water, where the proportion missing from 100% by weight is preferably water, and where the mass ratio of alkali metal atoms to aluminum sulfate (Al₂(SO₄)₃) is between 1 mg/g and 100 mg/g.

Further modifications and advantages of the invention will be apparent to the person skilled in the art from the working examples that follow.

### EXEMPLARY EMBODIMENTS

The following materials were used in the examples that follow:

| Name | Description |
|---|---|
| Al₂(SO₄)₃•approx. | Aluminum sulfate containing 17-18% Al₂O₃, |
| 14H₂O | in powder form |
| Water | Deionized water |
| Na aluminate A | Aqueous solution of sodium aluminate (contains |
| | 19% by weight of Na₂O and 24% by weight of |
| | Al₂O₃) |
| Na aluminate B | Powder containing at least 39% Na₂O and 53-55% |
| | Al₂O₃ |
| NaOH | Aqueous solution of NaOH (50% by weight) |
| Na₂CO₃ | Na₂CO₃•H₂O in powder form |
| KOH | KOH in powder form |
| LiOH | LiOH in powder form |
| KHCO₃ | KHCO₃ in powder form |

In the values stated below for the proportion of Al₂(SO₄)₃·approx. 14H2O, the water of crystallization is included. Al₂(SO₄)₃·approx. 14H₂O contains 57% by weight of Al₂(SO₄)₃. The water of crystallization is accordingly included in Na₂CO₃·H₂O too.

In the employed solutions of NaOH and sodium aluminate, the proportions of NaOH and NaAlO₂ in the values stated below relate to the NaOH and sodium aluminate as such, without the water of the solution. The latter is included under H₂O.

Viscosities were measured according to standard DIN EN ISO 2431:2011 using an ISO No. 6 cup at a temperature of 23° C. or an ISO No. 4 cup at a temperature of 23° C. “n.d.” in the tables below means that the viscosity could not be determined. The times listed in the tables below relate to the time t=0 that is the starting point at which all components of the mixture had been combined.

The components can generally be added to the mixture in powder form or as an aqueous solution. For example, material in powder form and an aqueous aluminum sulfate suspension are both suitable as starting material for the aluminum sulfate.

The aluminum sulfate suspensions produced according to the invention were found to be storage-stable over several months and have a viscosity suitable for practical applications as spray concrete accelerator in the region of <2000 mPa·s.

### Examples 1 to 4

### Production of Aluminum Sulfate Suspensions Containing Sodium Aluminate

A beaker was initially charged with a defined amount of water. While stirring (mechanical propeller stirrer at 650 rpm), the Al₂(SO₄)₃·approx. 14H₂O and sodium aluminate (0% to 4% by weight) were then added portionwise in the order and proportions stated in Table 1 and the suspension was stirred at room temperature for 6 h.

TABLE 1
Aluminum sulfate suspensions produced

Example

| Order | Substance | 1* | 2 | 3 | 4 |
|---|---|---|---|---|---|
| 1 | H₂O [% by wt.] | 40 | 39 | 38 | 36 |
| 2 | Na aluminate A [% by wt.] | — | 1 | 2 | 4 |
| 3 | Al₂(SO₄)₃•approx. 14H₂O | 60 | 60 | 60 | 60 |
| | [% by wt.] | | | | |

*Comparative example

The viscosity was measured after defined times. Table 2 gives an overview of the results.

TABLE 2
Dependence of viscosity on the proportion of sodium aluminate

Example

| | | | |
|---|---|---|---|
| 1* | 2 | 3 | 4 |

Proportion of Na aluminate A
[% by wt.]

| | | | |
|---|---|---|---|
| 0 | 1 | 2 | 4 |

Viscosity [mPa · s]

| | | | | |
|---|---|---|---|---|
| after 1 h | 669 | 385 | 200 | n.d. |
| after 2 h | 404 | 303 | 183 | 132 |
| after 3 h | 323 | 228 | 189 | 113 |
| after 4 h | 260 | 212 | 183 | 119 |
| after 5 h | 233 | 184 | 189 | 125 |
| after 6 h | 194 | 172 | 155 | 119 |
| after 24 h | 136 | 155 | 137 | 113 |
| after 48 h | 57 | 79 | 79 | 72 |
| after 16 days | 87 | 89 | 85 | 91 |

*Comparative example

As can be seen from Table 2, the viscosity of the aluminum sulfate suspension can, at a high aluminum sulfate content, be significantly reduced in the first hours by the addition of sodium aluminate.

### Examples 5 to 8

Production of aluminum sulfate suspensions containing sodium aluminate The experiments were carried out in the same way as examples 1 to 4 but with a change to the order of addition, as shown in Table 3.

TABLE 3
Aluminum sulfate suspensions produced

Example

| Order | Substance | 5* | 6 | 7 | 8 |
|---|---|---|---|---|---|
| 1 | H₂O [% by wt.] | 40 | 39 | 38 | 36 |
| 2 | Al₂(SO₄)₃•approx. 14H₂O | 20 | 20 | 20 | 20 |
| | [% by wt.] | | | | |
| 3 | Na aluminate A [% by wt.] | — | 1 | 2 | 4 |
| 4 | Al₂(SO₄)₃•approx. 14H₂O | 40 | 40 | 40 | 40 |
| | [% by wt.] | | | | |

*Comparative example

The viscosity was measured after defined times. Table 4 gives an overview of the results.

TABLE 4
Dependence of viscosity on the proportion of sodium aluminate

Example

| | | | |
|---|---|---|---|
| 5* | 6 | 7 | 8 |

Proportion of Na aluminate A
[% by wt.]

| | | | |
|---|---|---|---|
| 0 | 1 | 2 | 4 |

Viscosity [mPa · s]

| | | | | |
|---|---|---|---|---|
| after 1 h | 846 | 407 | 207 | 58 |
| after 2 h | 495 | 314 | 218 | 120 |
| after 3 h | 338 | 240 | 184 | 151 |
| after 4 h | 260 | 201 | 161 | 180 |
| after 5 h | 233 | 179 | 150 | 138 |
| after 6 h | 189 | 161 | 131 | 87 |
| after 24 h | 132 | 139 | 117 | 89 |
| after 48 h | 80 | 93 | 83 | 57 |

*Comparative example

As can be seen from Table 4, the viscosity of the aluminum sulfate suspension can, at a high aluminum sulfate content, be significantly reduced in the first hours by the addition of sodium aluminate.

### Examples 9 to 14

### Production of Aluminum Sulfate Suspensions Containing Sodium Aluminate

The experiments were carried out in the same way as examples 1 to 4 but with changes to the amount of sodium aluminate and to the order of addition, as shown in Table 5.

TABLE 5
Aluminum sulfate suspensions produced

| | | Example | | | | | |
|---|---|---|---|---|---|---|---|
| Order | Substance | 9 | 10 | 11 | 12 | 13 | 14 |
| 1 | H₂O [% by wt.] | 32 | 32 | 32 | 32 | 32 | 32 |
| 2 | Al₂(SO₄)₃•approx. | — | 10 | 20 | 30 | 40 | 50 |
| | 14H₂O [% by wt.] | | | | | | |
| 3 | Na aluminate A | 8 | 8 | 8 | 8 | 8 | 8 |
| | [% by wt.] | | | | | | |
| 4 | Al₂(SO₄)₃•approx. | 60 | 50 | 40 | 30 | 20 | 10 |
| | 14H₂O [% by wt.] | | | | | | |

The viscosity was measured after defined times. Table 6 gives an overview of the results.

TABLE 6
Dependence of viscosity on the split of the Al sulfate

| Example | 9 | 10 | 11 | 12 | 13 | 14 |
|---|---|---|---|---|---|---|
| Proportion of Na | 8 | 8 | 8 | 8 | 8 | 8 |
| aluminate A | | | | | | |
| [% by wt.] | | | | | | |
| | Viscosity [mPa · s] | | | | | |
| after 2 h | 983 | 502 | 972 | 980 | 976 | 818 |
| after 3 h | 983 | 512 | 908 | 795 | 812 | 722 |
| after 4 h | 510 | 369 | 509 | 488 | 430 | 510 |
| after 5 h | 417 | 316 | 382 | 370 | 321 | 381 |
| after 6 h | 318 | 236 | 294 | 296 | 268 | 281 |
| after 24 h | 142 | 124 | 142 | 124 | 134 | 136 |
| after 48 h | 98 | 89 | 95 | 90 | 89 | 93 |

### Examples 15 to 19

### Production of Aluminum Sulfate Suspensions Containing Sodium Aluminate

The experiments were carried out in the same way as examples 1 to 4 but using a different sodium aluminate (Na aluminate B) and with a change to the order of addition, as shown in Table 7.

TABLE 7
Aluminum sulfate suspensions produced

| | | Example | | | | |
|---|---|---|---|---|---|---|
| Order | Substance | 15* | 16 | 17 | 18 | 19 |
| 1 | H₂O [% by wt.] | 40 | 39.5 | 39 | 38 | 37 |
| 2 | Al₂(SO₄)₃ · approx. | 20 | 20 | 20 | 20 | 20 |
| | 14H₂O [% by wt.] | | | | | |
| 3 | Na aluminate B | — | 0.5 | 1 | 2 | 3 |
| | [% by wt.] | | | | | |
| 4 | Al₂(SO₄)₃ · approx. | 40 | 40 | 40 | 40 | 40 |
| | 14H₂O [% by wt.] | | | | | |

*Comparative example

The viscosity was measured after defined times. Table 8 gives an overview of the results.

TABLE 8
Dependence of viscosity on the sodium aluminate

| | Example | | | | |
|---|---|---|---|---|---|
| | 15* | 16 | 17 | 18 | 19 |
| | Proportion of Na aluminate B | | | | |
| | [% by wt.] | | | | |
| | 0 | 0.5 | 1 | 2 | 3 |
| | Viscosity [mPa · s] | | | | |
| after 1 h | 686 | 371 | 250 | 93 | 43** |
| after 2 h | 438 | 324 | 283 | 185 | 139 |
| after 3 h | 357 | 277 | 256 | 219 | 151 |
| after 4 h | 264 | 212 | 196 | 213 | 139 |
| after 5 h | 243 | 212 | 190 | 208 | 133 |
| after 6 h | 216 | 195 | 190 | 173 | 107 |
| after 24 h | 127 | 133 | 127 | 89 | 87 |
| after 48 h | 87 | 125 | 97 | 78 | 103 |

*Comparative example.
**Value inexact/measurement time too short for ISO No. 6

As can be seen from Table 8, the viscosity of the aluminum sulfate suspension can, at a high aluminum sulfate content, be significantly reduced in the first hours by the addition of sodium aluminate.

### Examples 20 to 25

### Production of Aluminum Sulfate Suspensions Containing Sodium Aluminate

The experiments were carried out in the same way as examples 1 to 4 but using a different sodium aluminate (Na aluminate B), as shown in Table 9.

TABLE 9
Aluminum sulfate suspensions produced

| | | Example | | | | | |
|---|---|---|---|---|---|---|---|
| Order | Substance | 20* | 21 | 22 | 23 | 24 | 25 |
| 1 | H₂O [% by wt.] | 40 | 39.5 | 39 | 38 | 37 | 36 |
| 2 | Al₂(SO₄)₃ · approx. | 60 | 60 | 60 | 60 | 60 | 60 |
| | 14H₂O [% by wt.] | | | | | | |
| 3 | Na aluminate B | — | 0.5 | 1 | 2 | 3 | 4 |
| | [% by wt.] | | | | | | |

*Comparative example

The viscosity was measured after defined times. Table 10 gives an overview of the results.

TABLE 10
Dependence of viscosity on the amount of sodium aluminate

| Example | 20* | 21 | 22 | 23 | 24 | 25 |
|---|---|---|---|---|---|---|
| Proportion of Na | 0 | 0.5 | 1 | 2 | 3 | 4 |
| aluminate A | | | | | | |
| [% by wt.] | | | | | | |
| | Viscosity [mPa · s] | | | | | |
| after 1 h | 513 | 249 | n.d. | n.d. | n.d. | n.d. |
| after 2 h | 352 | 200 | 234 | n.d. | n.d. | n.d. |
| after 3 h | 226 | 178 | 195 | 162 | 126 | 81 |
| after 4 h | 199 | 155 | 178 | 162 | 113 | 81 |
| after 5 h | 165 | 149 | 155 | 150 | 80 | 94 |
| after 6 h | 136 | 143 | 155 | 132 | 34* | 94 |
| after 24 h | 102 | 115 | 126 | 74 | 52 | 98 |
| after 48 h | 70 | 110 | 84 | 63 | 60 | 105 |

**Value inexact

As can be seen from Table 10, the viscosity of the aluminum sulfate suspension can, at a high aluminum sulfate content, be significantly reduced in the first hours by the addition of sodium aluminate.

### Examples 26 to 31

Production of aluminum sulfate suspensions containing sodium aluminate The experiments were carried out in the same way as examples 1 to 4 but using a different sodium aluminate (Na aluminate B) and with a change to the order of addition, as shown in Table 11. In addition, a higher aluminum sulfate concentration was used, with a dissolver disk used for stirring instead of the propeller stirrer. In all experiments a loss of water was registered, which was not compensated for.

TABLE 11
Aluminum sulfate suspensions produced

| | | Example | | | | | |
|---|---|---|---|---|---|---|---|
| Order | Substance | 26* | 27 | 28 | 29 | 30 | 31 |
| 1 | H₂O [% by wt.] | 35 | 34.5 | 34 | 33 | 32 | 31 |
| 2 | Al₂(SO₄)₃ · approx. | 30 | 30 | 30 | 30 | 30 | 30 |
| | 14H₂O [% by wt.] | | | | | | |
| 3 | Na aluminate B | — | 0.5 | 1 | 2 | 3 | 4 |
| | [% by wt.] | | | | | | |
| 4 | Al₂(SO₄)₃ · approx. | 35 | 35 | 35 | 35 | 35 | 35 |
| | 14H₂O [% by wt.] | | | | | | |

*Comparative example

The viscosity was measured after defined times. Table 12 gives an overview of the results.

TABLE 12
Dependence of viscosity on the amount of Na aluminate

| Example | 26* | 27 | 28 | 29 | 30 | 31 |
|---|---|---|---|---|---|---|
| Proportion of Na | 0 | 0.5 | 1 | 2 | 3 | 4 |
| aluminate B | | | | | | |
| [% by wt.] | | | | | | |
| | Viscosity [mPa · s] | | | | | |
| after 4 h | 1167 | 914 | 831 | 442 | 419 | 539 |
| after 5 h | 1076 | 843 | 770 | 453 | 392 | 512 |
| after 6 h | 1071 | 818 | 750 | 432 | 370 | 496 |
| after 24 h | 708 | 757 | 953 | 432 | 300 | 346 |
| after 48 h | 368 | 365 | 414 | 270 | 233 | 335 |

*Comparative example

As can be seen from Table 12, the viscosity of the aluminum sulfate suspension can, even at a very high aluminum sulfate content, be significantly reduced in the first hours by the addition of sodium aluminate.

### Examples 32 to 37

### Production of Aluminum Sulfate Suspensions Containing Sodium Hydroxide

The experiments were carried out in the same way as examples 1 to 4 but using sodium hydroxide solution (50%) as the alkali metal compound instead of sodium aluminate, as shown in Table 13.

TABLE 13
Aluminum sulfate suspensions produced

| | | Example | | | | | |
|---|---|---|---|---|---|---|---|
| Order | Substance | 32* | 33 | 34 | 35 | 36 | 37 |
| 1 | H₂O [% by wt.] | 40 | 39 | 38 | 36 | 34 | 32 |
| 2 | NaOH [% by wt.] | — | 1 | 2 | 4 | 6 | 8 |
| 3 | Al₂(SO₄)₃ · approx. | 60 | 60 | 60 | 60 | 60 | 60 |
| | 14H₂O [% by wt.] | | | | | | |

*Comparative example

The viscosity was measured after defined times. Table 14 gives an overview of the results.

TABLE 14
Dependence of viscosity on the amount of NaOH

| Example | 32* | 33 | 34 | 35 | 36 | 37 |
|---|---|---|---|---|---|---|
| Proportion of | 0 | 1 | 2 | 4 | 6 | 8 |
| NaOH [% by wt.] | | | | | | |
| | Viscosity [mPa · s] | | | | | |
| after 1 h | 966 | 447 | 201 | 72 | 49 | 53 |
| after 2 h | 660 | 432 | 234 | 101 | 61 | 52 |
| after 3 h | 410 | 293 | 212 | 147 | 162 | 68 |
| after 4 h | 390 | 277 | 207 | 135 | 169 | 70 |
| after 5 h | 328 | 228 | 179 | 103 | 169 | 70 |
| after 6 h | 313 | 190 | 184 | 98 | 168 | 72 |
| after 24 h | 145 | 130 | 127 | 74 | 101 | 57 |
| after 48 h | 87 | 130 | 95 | 68 | 85 | 56 |

*Comparative example

As can be seen from Table 14, the viscosity of the aluminum sulfate suspension can, at a high aluminum sulfate content, be significantly reduced in the first hours by the addition of NaOH.

### Examples 38 to 43

### Production of Aluminum Sulfate Suspensions Containing Sodium Carbonate

The experiments were carried out in the same way as examples 1 to 4 but using sodium carbonate as the alkali metal compound instead of sodium aluminate and with a change to the order of addition, as shown in Table 15.

TABLE 15
Aluminum sulfate suspensions produced

| | | Example | | | | | |
|---|---|---|---|---|---|---|---|
| Order | Substance | 38* | 39 | 40 | 41 | 42 | 43 |
| 1 | H₂O [% by wt.] | 40 | 39.5 | 39 | 38 | 37 | 36 |
| 2 | Al₂(SO₄)₃ · approx. | 60 | 60 | 60 | 60 | 60 | 60 |
| | 14H₂O [% by wt.] | | | | | | |
| 3 | Na₂CO₃ [% by wt.] | — | 0.5 | 1 | 2 | 3 | 4 |

*Comparative example

The viscosity was measured after defined times. Table 16 gives an overview of the results.

TABLE 16
Dependence of viscosity on the amount of Na₂CO₃

| Example | 38* | 39 | 40 | 41 | 42 | 43 |
|---|---|---|---|---|---|---|
| Proportion of | 0 | 0.5 | 1 | 2 | 3 | 4 |
| Na₂CO₃ [% by wt.] | | | | | | |
| | Viscosity [mPa · s] | | | | | |
| after 1 h | 947 | 391 | 367 | 162 | 645** | 50** |
| after 2 h | 903 | 386 | 372 | 174 | 594 | 50 |
| after 3 h | 370 | 228 | 245 | 185 | 774 | n.d. |
| after 4 h | 354 | 206 | 235 | 174 | 814 | n.d. |
| after 5 h | 318 | 228 | 272 | 156 | 624 | 442 |
| after 6 h | 313 | 217 | 262 | 168 | 629 | 437 |
| after 24 h | 158 | 132 | 161 | 134 | 83 | 87 |
| after 48 h | 100 | 139 | 115 | 98 | 73 | 77 |

*Comparative example.
**Extrapolated

As can be seen from Table 16, the viscosity of the aluminum sulfate suspension can, at a high aluminum sulfate content, be significantly reduced in the first hours by the addition of Na₂CO₃.

### Examples 44 to 49

### Production of Aluminum Sulfate Suspensions Containing Potassium Hydroxide

The experiments were carried out in the same way as examples 1 to 4 but using potassium hydroxide as the alkali metal compound instead of sodium aluminate and with a change to the order of addition, as shown in Table 17.

TABLE 17
Aluminum sulfate suspensions produced

| | | Example | | | | | |
|---|---|---|---|---|---|---|---|
| Order | Substance | 44* | 45 | 46 | 47 | 48 | 49 |
| 1 | H₂O [% by wt.] | 40 | 39.5 | 39 | 38 | 37 | 36 |
| 2 | Al₂(SO₄)₃ · approx. | 60 | 60 | 60 | 60 | 60 | 60 |
| | 14H₂O [% by wt.] | | | | | | |
| 3 | KOH [% by wt.] | — | 0.5 | 1 | 2 | 3 | 4 |

*Comparative example

The viscosity was measured after defined times. Table 18 gives an overview of the results.

TABLE 18
Dependence of viscosity on the amount of KOH

| Example | 44* | 45 | 46 | 47 | 48 | 49 |
|---|---|---|---|---|---|---|
| Proportion of KOH | 0 | 0.5 | 1 | 2 | 3 | 4 |
| [% by wt.] | | | | | | |
| | Viscosity [mPa · s] | | | | | |
| after 1 h | 1385 | 731 | n.d. | 207 | 65** | — |
| after 2 h | 968 | n.d. | 360 | 218 | 80 | 42 |
| after 3 h | 657 | n.d. | 360 | 212 | 78 | 50 |
| after 4 h | 502 | 344 | 292 | 229 | 85 | 72 |
| after 5 h | 426 | 271 | 217 | 207 | 82 | 86** |
| after 6 h | 406 | 234 | 195 | 201 | 88 | 100 |
| after 24 h | 182 | 117 | 155 | 192 | 53 | 78 |
| after 48 h | 80 | 73 | 115 | 187 | 60 | 79 |

*Comparative example.
**Extrapolated

As can be seen from Table 18, the viscosity of the aluminum sulfate suspension can, at a high aluminum sulfate content, be significantly reduced in the first hours by the addition of KOH.

### Examples 50 to 55

### Production of Aluminum Sulfate Suspensions Containing Lithium Hydroxide

The experiments were carried out in the same way as examples 1 to 4 but using lithium hydroxide as the alkali metal compound instead of sodium aluminate and with a change to the order of addition, as shown in Table 19.

TABLE 19
Aluminum sulfate suspensions produced

| | | Example | | | | | |
|---|---|---|---|---|---|---|---|
| Order | Substance | 50* | 51 | 52 | 53 | 54 | 55 |
| 1 | H₂O [% by wt.] | 40 | 39.5 | 39 | 38 | 37 | 36 |
| 2 | Al₂(SO₄)₃ · approx. | 60 | 60 | 60 | 60 | 60 | 60 |
| | 14H₂O [% by wt.] | | | | | | |
| 3 | LiOH [% by wt.] | — | 0.5 | 1 | 2 | 3 | 4 |

*Comparative example

The viscosity was measured after defined times. Table 20 gives an overview of the results.

TABLE 20
Dependence of viscosity on the amount of LiOH

| Example | 50* | 51 | 52 | 53 | 54 | 55 |
|---|---|---|---|---|---|---|
| Proportion of LiOH | 0 | 0.5 | 1 | 2 | 3 | 4 |
| [% by wt.] | | | | | | |
| | Viscosity [mPa · s] | | | | | |
| after 1 h | 767 | 345 | 93 | —*** | —*** | —*** |
| after 2 h | 767 | 365 | 184 | —*** | —*** | 86 |
| after 3 h | 578 | 287 | 184 | 50** | —*** | 178 |
| after 4 h | 412 | 228 | 173 | 79 | 65 | 99 |
| after 5 h | 376 | 137 | 161 | 99 | 65 | 119 |
| after 6 h | 324 | 178 | 161 | 93 | 72 | 99 |
| after 24 h | 133 | 101 | 105 | 81 | 71 | 86 |
| after 48 h | 95 | 157 | 77 | 72 | 72 | 90 |

*Comparative example.
**Value inexact.
***Measurement time for ISO No. 6 too short (i.e. viscosity too low for measurement method)

As can be seen from Table 20, the viscosity of the aluminum sulfate suspension can, at a high aluminum sulfate content, be significantly reduced in the first hours by the addition of LiOH.

### Examples 56 to 61

### Production of Aluminum Sulfate Suspensions Containing Potassium Hydrogen Carbonate

The experiments were carried out in the same way as examples 1 to 4 but using potassium hydrogen carbonate as the alkali metal compound instead of sodium aluminate and with a change to the order of addition, as shown in Table 21.

TABLE 21
Aluminum sulfate suspensions produced

| | | Example | | | | | |
|---|---|---|---|---|---|---|---|
| Order | Substance | 56* | 57 | 58 | 59 | 60 | 61 |
| 1 | H₂O [% by wt.] | 40 | 39.5 | 39 | 38 | 37 | 36 |
| 2 | Al₂(SO₄)₃ · approx. | 60 | 60 | 60 | 60 | 60 | 60 |
| | 14H₂O [% by wt.] | | | | | | |
| 3 | KHCO₃ [% by wt.] | — | 0.5 | 1 | 2 | 3 | 4 |

*Comparative example

The viscosity was measured after defined times. Table 22 gives an overview of the results.

TABLE 22
Dependence of viscosity on the amount of KHCO₃

| Example | 50* | 51 | 52 | 53 | 54 | 55 |
|---|---|---|---|---|---|---|
| Proportion of | 0 | 0.5 | 1 | 2 | 3 | 4 |
| KHCO₃ | | | | | | |
| [% by wt.] | | | | | | |
| | Viscosity [mPa · s] | | | | | |
| after 1 h | 677 | 662 | 391 | 239 | 93 | 106 |
| after 2 h | 657 | 653 | 427 | 239 | 119 | 131 |
| after 3 h | 498 | 452 | 355 | 245 | 131 | 131 |
| after 4 h | 422 | 401 | 303 | 217 | 119 | 106 |
| after 5 h | 386 | 335 | 261 | 206 | 131 | 119 |
| after 6 h | 314 | 298 | 223 | 190 | 125 | 112 |
| after 24 h | 157 | 154 | 144 | 133 | 98 | 103 |
| after 48 h | 94 | 101 | 112 | 106 | 90 | 108 |

*Comparative example

As can be seen from Table 22, the viscosity of the aluminum sulfate suspension can, at a high aluminum sulfate content, be significantly reduced in the first hours by the addition of potassium hydrogen carbonate.

### Summary of the Results

As can be seen from the examples, the viscosity of the aluminum sulfate suspension can, even at a high aluminum sulfate content, be significantly reduced in the first hours by the addition of soluble alkali metal compounds. In particular, the spikes in viscosity that commonly occur at the start can be avoided.

Accordingly, a soluble alkali metal compound can be used to control the viscosity of an aluminum sulfate suspension. The order of addition and the split in the components play no important role.

All experiments were carried out at room temperature. As is known, a decrease in viscosity can generally be achieved by heating, but the time and energy required make this undesirable. The inventive use of soluble alkali metal compounds means that heating to a lower temperature is sufficient or allows heating to be avoided altogether.

In addition, it has been found that the viscosities of the aluminum sulfate suspension thus produced can be maintained over 3 months without significant change.

The above-described aluminum sulfate suspensions have been found to be excellent accelerators for spray concrete and spray mortar.

Although the above-described embodiments of the invention are preferred, it will be apparent that the invention is not limited to these embodiments and can be modified as desired within the scope of the disclosure.

1. A method for adjusting the viscosity of an aluminum sulfate suspension comprising a step of mixing at least one soluble alkali metal compound, aluminium sulfate, and water, wherein the alkali metal is selected from sodium, potassium and/or lithium.

2. The method of claim 1, wherein the aluminum sulfate suspension is a solidification accelerator and/or hardening accelerator for a composition comprising a mineral binder, wherein the aluminum sulfate suspension is preferably a spray concrete accelerator.

3. The method of claim 1, wherein the alkali metal compound is an aluminate, oxide, hydroxide, carbonate, hydrogen carbonate, nitrate, sulfate, phosphate, halide, formate, citrate, thiocyanate, silicate and/or acetate.

4. The method of claim 1, wherein the alkali metal compound is selected from sodium aluminate, sodium carbonate, sodium bicarbonate, sodium oxide, sodium hydroxide, potassium aluminate, potassium carbonate, potassium bicarbonate, potassium oxide, potassium hydroxide, lithium aluminate, lithium carbonate, lithium bicarbonate, lithium oxide, lithium hydroxide or a mixture thereof.

5. The method of claim 1, wherein an amount of the at least one alkali metal compound is chosen such that the alkali metal atoms, based on the total weight of the aluminum sulfate suspension, have a proportion of 0.02-5% by weight.

6. The method of claim 1, wherein the aluminum sulfate suspension, based on the total weight of the aluminum sulfate suspension, has a proportion of sulfate (SO₄⁻) of 19-40% by weight, and wherein the aluminum sulfate suspension, based on the total weight of the aluminum sulfate suspension, has a proportion of aluminum (Al) of 3.5-10% by weight.

7. The method of claim 1, wherein the aluminum sulfate suspension, based on the total weight of the aluminum sulfate suspension, contains 22-46% by weight of aluminum sulfate (Al₂(SO₄)₃).

8. The method of claim 1, wherein the aluminum sulfate suspension, based on the total weight of the aluminum sulfate suspension, contains 0.01-15% by weight of aluminum hydroxide.

9. The method of claim 1, wherein a molar ratio of aluminum to sulfate in the aluminum sulfate suspension is less than or equal to 0.9.

10. The method of claim 1, wherein the aluminum sulfate suspension additionally contains 0.1-15% by weight, based on the total weight of the aluminum sulfate suspension, of an alkanolamine, wherein the alkanolamine used is advantageously monoethanolamine, diethanolamine, triethanolamine and/or methyldiisopropanolamine.

11. The method of claim 1, wherein the alkali metal compound is added to the aluminum sulfate suspension or during the production of the aluminum sulfate suspension in powder form or as an aqueous solution.

12. The method of claim 1, wherein the alkali metal compound is used for reducing viscosity in combination with a calcium compound or a magnesium compound.

13. The method of claim 12, wherein the calcium compound or magnesium compound is an oxide, hydroxide, carbonate, nitrate, sulfate, phosphate, halide, formate, acetate and/or citrate.

14. The method of claim 12, wherein the calcium compound is calcium carbonate, calcium oxide and/or calcium hydroxide and the magnesium compound is magnesium carbonate, magnesium oxide and/or magnesium hydroxide.

15. The method of claim 12, wherein an amount of the calcium compound or magnesium compound is chosen such that the calcium atoms or magnesium atoms, based on the total weight of the aluminum sulfate suspension, have a proportion of 0.001-4% by weight.

16. A solidification accelerator and/or hardening accelerator for a composition comprising a mineral binder, wherein the solidification accelerator and/or hardening accelerator is a spray concrete accelerator, comprising:
a) 22-46% by weight of aluminum sulfate (Al₂(SO₄)₃;
b) optionally 0.01-15% by weight of aluminum hydroxide (Al(OH)₃);
c) optionally 0.001-5% by weight of a calcium compound selected from calcium oxide and/or calcium hydroxide or of a magnesium compound selected from magnesium oxide and/or magnesium hydroxide;
d) optionally 0.001-10% by weight of iron;
e) optionally 0.001% to 5% by weight of silicon dioxide;
f) at least one soluble alkali metal compound, the alkali metal being selected from sodium, potassium and/or lithium, in an amount such that the alkali metal atoms, based on the total weight of the aluminum sulfate suspension, have a proportion of 0.02-5% by weight;
g) optionally 0.1-15% by weight of alkanolamine;
h) optionally 0.01-10% by weight of fluoride;
i) and water, where the proportion missing from 100% by weight is water.

17. A solidification accelerator and/or hardening accelerator as claimed in claim 16, wherein the alkali metal compound is selected from sodium aluminate, sodium carbonate, sodium bicarbonate, sodium oxide, sodium hydroxide, potassium aluminate, potassium carbonate, potassium bicarbonate, potassium oxide, potassium hydroxide, lithium aluminate, lithium carbonate, lithium bicarbonate, lithium oxide, lithium hydroxide or a mixture thereof.
